(19) United States
(12) Patent Application Publication
(10) Pub. No.: US 2005/0167271 A1
(43) Pub. Date: Aug. 4, 2005

(54) Separation systems with charge mosaic membrane

(76) Inventor: Ryszard Gajek, MARTINEZ, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/506,517

(22) PCT Filed: Apr. 2, 2002
(86) PCT No.: PCT/US02/10444

(51) Int. Cl. G01N 27/27

(52) U.S. Cl. 204/600

(57) ABSTRACT

An ion is eluted from an ion exchange resin (132) in a separation system (100) using an eluent generated by electrolysis of a medium. Elution is further assisted by an electrical field between two electrodes (120, 110), wherein the ion exchange resin (132) is at least partially disposed between the electrodes. Particularly preferred aspects of such separation systems include gradient separation and buffered electrodialysis.

### FIELD OF THE INVENTION

The field of the invention is electrophoresis-assisted separation of ionic species.

### BACKGROUND OF THE INVENTION

Numerous disciplines in science and technology require separation and/or analysis of complex mixtures, or quantification, concentration, and/or removal of various analytes from such mixtures and there are various separation technologies known in the art.

For example, individual analytes can be separated or isolated from mixtures using molecular weight differences between the analyte and the remaining compounds in the mixture. Size discrimination may be performed by size exclusion (e.g., using microporous matrix) or by molecular sieving (e.g., using crosslinked matrix). While separations based on molecular weight differences are typically relatively independent on buffer conditions and other extraneous factors, resolution between analytes will often become increasingly problematic as the molecular weight difference decreases.

In another example, individual analytes can be separated or isolated from mixtures using differences in hydrophobicity between the analyte and the remaining compounds in the mixture. Numerous separation systems that employ such differences are known in the art, and among other systems, reversed phase high performance liquid chromatography (HPLC) affords a relatively high resolution among relatively chemically similar compounds. However, many of such systems are difficult to operate when the volume of the sample is relatively large (e.g., several liters). Furthermore, HPLC systems are relatively expensive and frequently require extensive maintenance.

Alternatively, individual analytes can be separated or isolated from mixtures using differences in their net charge at a particular pH and/or ionic strength in the sample. Typically such systems include a cation exchange material or an anion exchange material to which one or more analytes are bound and eluted using an external elution reagent. Ion exchange separation is a relatively common separation technology that is in many cases inexpensive and frequently has a desirable resolution. However, various difficulaties remain. Among other things, elution of a bound analyte will place the analyte in an environment that may not be compatible with further use or that may even interfere with the analyte's integrity of function.

Still further, analytes may be separated or isolated from mixtures using differences in their affinity towards a typically immobilized and highly specific binding agent. Such affinity chromatographic separations are generally highly specific and frequently allow gentle separation of the analyte from the binding agent. However, many affinity reagents are relatively expensive (e.g., monoclonal antibodies) or may not be available for a desired analyte.

In still further known systems, two or more physico-chemical properties of an analyte are employed for separation of the analyte from a mixture of compounds. For example, isoelectric focusing combines pH-dependent variability of an analyte with electric mobility of the analyte in an electrophoresis-type of separation. In another example, gel electrophoresis employs molecular weight and electric charge of an electrolyte. While many of the separation systems improve at least some aspects of resolution of a desired analyte, various problems still remain. For example, analyte recovery is frequently problematic. Furthermore, large scale preparation of analytes is often impracticable. Thus, despite various known configurations and methods for separation of an analyte from a medium, all or almost all suffer from various problems. Therefore, there is still a need to provide improved configurations and methods for separation systems.

### SUMMARY OF THE INVENTION

The present invention is directed to configurations and methods of a separation system in which an analyte in ionic form is eluted from an ion exchange resin using an electric field and an eluent, wherein the electric field and the eluent are generated by a pair of electrodes in the system.

In one aspect of the inventive subject matter, contemplated systems comprise a cathode, an anode, and a first ion (e.g., anion) bound by a first ion exchange resin (e.g., anion exchange resin) that is at least partially disposed between the cathode and the anode and that is separated from at least one of the anode and cathode (e.g., cathode) by a charge mosaic membrane (CMM), wherein the cathode, the anode, and the ion exchange resin are at least partially disposed in a medium, and wherein the first ion detaches from the ion exchange resin at (a) a particular voltage applied between the anode and cathode and (b) a particular electroactivity of a second ion (e.g., hydroxyl ion) generated by electrolysis of the medium (e.g., water).

Particularly contemplated systems comprise a second ion exchange resin (e.g., cation exchange resin) at least partially disposed between the anode and the first ion exchange resin, wherein a cation exchange membrane is at least partially disposed between the first and second ion exchange resin.

Thus, viewed from another perspective, contemplated systems may comprise an ion exchange resin that binds an ion from a fluid, wherein the ion is eluted from the resin using (a) an electric field generated between an cathode and a anode and (b) a second ion that is generated by electrolysis of the fluid by the cathode and the anode. In such systems, it is preferred that a charge mosaic membrane separates the ion exchange resin from the cathode, thereby allowing migration of OH⁻ ions from the cathode to the ion exchange resin and migration of cations from the ion exchange resin to the cathode. While it is generally contemplated that all or almost all ions may be eluted from the resin using the electrical field and/or the eluent, additional eluents (e.g., a third ion) may be employed.

In a further aspect of the inventive subject matter, contemplated systems may be employed to separate multiple components from a sample for analytical or preparative purposes. Consequently, suitable systems may include a third ion that binds to the ion exchange resin, wherein the third ion elutes at an electric field and concentration of the second ion that is different from the elution of the ion from the fluid. Especially contemplated fluids and/or media include crude, partially purified and/or highly purified preparations/isolates from various sources, including (bio)synthetic fluids, biological fluids, waste fluids, etc.

Viewed from yet another perspective, contemplated systems may include a charge mosaic membrane coupled to an ion exchange resin that binds an ion from a fluid and wherein the ion is eluted at least in part from the resin using an eluent that is generated by electrolysis of the fluid.

Various objects, features, aspects, and advantages of the present invention will become more apparent from the following detailed description of preferred embodiments of the invention, along with the accompanying drawing.

### BRIEF DESCRIPTION OF THE DRAWING

FIG. 1 is a schematic view of an exemplary CMM gradient separation system.

FIG. 2 is a schematic view of an exemplary CMM buffered electrodialysis system.

FIG. 3 is a schematic view of an exemplary CMM buffered electrodialysis system.

FIG. 4 is a schematic view of an exemplary CMM gradient electrophoresis system.

### DETAILED DESCRIPTION

The inventors have discovered that ions may be selectively eluted from an ion exchange resin using an electric field and an eluent, wherein the electric field and the eluent are generated by electrodes that are proximal to ion exchange resin.

More specifically, the inventors discovered that a separation system may comprise a charge mosaic membrane coupled to an ion exchange resin that binds an ion from a fluid and wherein the ion is eluted at least in part from the resin using an eluent that is generated by electrolysis of the fluid. Viewed from another perspective, contemplated separation systems may include an ion exchange resin that binds an ion from a fluid, wherein the ion is eluted from the resin using (a) an electric field generated between an cathode and a anode and (b) a second ion that is generated by electrolysis of the fluid by the cathode and the anode.

In a particularly preferred configuration, a separation system has a cathode, an anode, and a first ion bound by a first ion exchange resin that is at least partially disposed between the cathode and the anode and separated from at least one of the anode and cathode by a charge mosaic membrane, wherein the cathode, the anode, and the ion exchange resin are at least partially disposed in a medium, and wherein the first ion is eluted from the resin using (a) a particular voltage that is applied between the anode and cathode and (b) a second ion that is generated by electrolysis of the medium and moves from the cathode to the anode by the electric field generated by the particular voltage.

As used herein, the terms “ion bound by an ion exchange resin” and “ion exchange resin that binds an ion” refer to non-covalent, ionic binding between the ion and an ionic or polar group of the ion exchange resin. Consequently, the terms “the ion is eluted from the resin” and “the ion elutes from the resin” refer to breaking of the non-covalent, ionic bond between the ion and an ionic or polar group of the ion exchange resin, wherein the breaking of the bond may be effected by (a) an electric field force that attracts the ion towards an electrode with opposite polarity, (b) competition for the ionic or polar group of the ion exchange resin by another ion (same type of ion at higher concentration and/or different ion), and/or (c) kinetic forces acting on the ion (e.g., heat, molecular collisions, etc.).

As also used herein, the term “disposed between the cathode and the anode” refers to a position that intersects or coincides with part of at least one of a plurality of straight lines between the cathode and the anode. Similarly, the term “disposed between the cathode (or anode) and the first ion exchange resin” refers to a position that intersects or coincides with part of at least one of a plurality of straight lines between the cathode (or anode) and the first ion exchange resin.

As still further used herein, the term “charge mosaic membrane” refers to a membrane or other support that includes a plurality of charged groups, wherein some of the charged groups are positively charged (e.g., quaternary ammonium groups), wherein other groups are negatively charged (e.g., sulfonic acid groups), and wherein the plurality of charged groups are disposed in the membrane or other support such that selected cations and anions (e.g., H⁺ and OH⁻) can penetrate the membrane or other support while blocking transport of solvent and/or other ions (e.g., proteins with MW of about 30,000 Dalton).

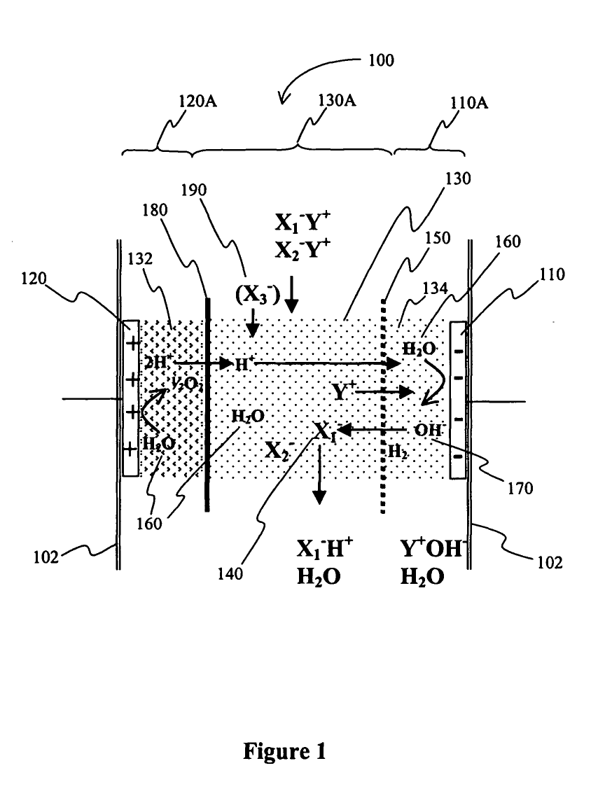

In an especially preferred aspect of the inventive subject matter, an exemplary separation system is configured to operate as a CMM-gradient separation system. Here, as depicted in FIG. 1 a CMM separation system 100 has a housing 102 that at least partially encloses an anode compartment 120A with anode 120, a cathode compartment 110A with cathode 110, and an analyte compartment 130 that is separated from the anode compartment 120A via cation exchange membrane 180 and that is separated from the cathode compartment 110A via charge mosaic membrane 150. The anode compartment 120A further includes cation exchange resin 132, while the analyte compartment 130A and the cathode compartment 110A include anion exchange resin 130 and 134, respectively.

Anode, cathode, and analyte compartment further include a medium comprising water 160. At least a portion of the water is electrolyzed via the anode and cathode, wherein oxygen evolves in the anode compartment, hydrogen evolves in the cathode compartment, and wherein H⁺ is generated in the anode compartment and OH⁻ is generated in the cathode compartment. The protons generated in the anode compartment will be (via cation exchange resin and cation exchange membrane) transported to the analyte compartment and further (via charge mosaic membrane) to the cathode compartment. Similarly, the OH⁻ ions generated in the cathode compartment will be transported (via anion exchange resin and charge mosaic membrane) into the analyte compartment comprising anion exchange resin. However, further passage of the OH⁻ ions to the anode compartment is blocked by the cation exchange membrane.

A sample comprising ionic species X₁⁻Y₁⁺ and X₂⁻Y₂⁺ is applied to the analyte compartment, and the anionic portions of the sample X₁⁻ (e.g., first ion 140) and X₂⁻ will be bound to the anion exchange resin in the analyte compartment. Upon application of a electric potential between the anode and the cathode, an electric force will act upon the bound anions. Furthermore, electrolysis of water by the electrodes will proved OH⁻ anions that will move from the cathode compartment via the anion exchange resin to the analyte compartment. Thus, an increasing electrical potential between the electrodes will act in at least two ways upon the anions bound to the anion exchange resin in the analyte compartment. First, an electrophoretic force will increasingly move the bound anions according to their strength with which they bind to the anion exchange material. Second, the OH⁻ ions in the analytic compartment will increasingly compete for interaction with the anion exchange resin. Consequently, it should be recognized that a particular anion will elute from the anion exchange resin by (a) generation of (and competition with) an anion that is generated from the medium by electrolysis, and (b) at a particular voltage applied to the anode and cathode (via an electrophoretic effect). Additionally, elution may further be assisted by competition with a further anion (as used in conventional ion exchange chromatography).

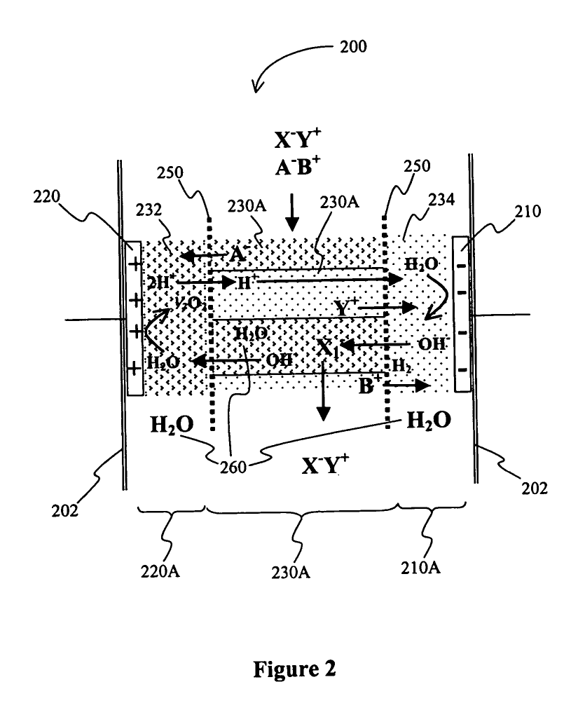

Alternatively, as depicted in FIG. 2, an exemplary separation system is configured to operate as a CMM-buffered electrodialysis system. Here, the separation system 200 has a housing 202 that at least partially encloses cathode 210 and anode 220. The housing cooperates with charge mosaic membranes 250 to define a anode compartment 220A, an analyte compartment 230A, and a cathode compartment 210A. The anode compartment 220A is at least partially filled with cation exchange resin 232 while the cathode compartment 210A is at least partially filled with anion exchange resin 232. The analyte compartment includes an ordered mixed bed comprising alternate layers of cation exchange resin 230A and anion exchange resin 230A′.

Anode, cathode, and analyte compartment further include a medium comprising water 260. At least a portion of the water is electrolyzed via the anode and cathode, wherein oxygen evolves in the anode compartment, hydrogen evolves in the cathode compartment, and wherein H⁺ is generated in the anode compartment and OH⁻ is generated in the cathode compartment. The protons generated in the anode compartment will be (via cation exchange resin and cation exchange membrane) transported to the analyte compartment and further (via cation exchange resin and charge mosaic membrane) to the cathode compartment. Similarly, the OH⁻ ions generated in the cathode compartment will be transported (via anion exchange resin and charge mosaic membrane) into the analyte compartment comprising anion exchange resin, and further (via anion exchange resin and charge mosaic membrane) to the cathode compartment.

A sample comprising ionic species X⁻Y⁺ and A⁻B⁺ is applied to the analyte compartment, and the anionic portions of the sample X⁻ and A⁻ will be bound to the anion exchange resin in the analyte compartment. Similarly, the cationic portions of the sample Y⁺ and B⁺ will be bound to the cation exchange resin in the analyte compartment. Upon application of an electric potential between the anode and the cathode, an electric force will act upon the bound anions and cations. Furthermore, electrolysis of water by the electrodes will provide OH⁻ anions and protons that will move from the electrode of their origin to the electrode with opposite polarity.

Thus, an increasing electrical potential between the electrodes will act in at least two ways upon the anions and cations bound to the anion and cation exchange resin in the analyte compartment. First, an electrophoretic force will increasingly move the bound anions cations according to their strength with which they bind to the ion exchange material. Second, the OH⁻ ions and protons in the analytic compartment will increasingly compete for interaction with the anion exchange resin as the electric field strength increases. Consequently, it should be recognized that a particular anion and a particular cation will elute from the ion exchange resin by (a) generation of (and competition with) an anion and cation that is generated from the medium by electrolysis, and (b) at a particular voltage applied to the anode and cathode (via an electrophoretic effect). Thus, it should be further recognized that ions will typically elute as ion pairs (hence the term ‘buffered CMM electrodialysis’) from the ion exchange resin. Additionally, elution may further be assisted by competition with a further anions and/or cations (as used in conventional ion exchange chromatography).

With respect to the housing, it is contemplated that the size, configuration and material may vary considerably, and a particular housing will typically be determined at least in part by the particular function of the device and type of sample. However, it is generally contemplated that the housing is configured to at least partially enclose the cathode compartment, the analytical compartment, and/or the anode compartment. Furthermore, suitable housings typically enclose at least part of the electrodes (which may also be integral part of the housing). Moreover, it is generally preferred that the materials for the housing (or at least the materials contacting the anode, analyte, and cathode compartment are chemically and electrically inert (i.e., do not react with a desired analyte and/or solvent and have a resistivity of at least 1 MOhm).

Consequently, suitable housings may be fabricated from numerous materials, and contemplated materials include natural and synthetic polymers, metals, glass, and all reasonable combinations thereof. Furthermore, where contemplated devices are employed to isolate one or more analytes from a relatively large volume (e.g., several liters to several hundred liters, and even more), the housing may be configured as a tank, and the separation may be performed batch-wise. On the other hand, where a continuous flow of sample is preferred, the housing may be configured as a column (i.e., generally cylindrical with open ends).

Similarly, contemplated electrodes may be manufactured from a variety of materials, and it is generally contemplated that the particular nature of an electrode will at least partially depend on the particular sample, size of the electrode, and/or strength of the electric field. However, in especially preferred aspects of the inventive subject matter, suitable electrodes include platinum, or platinum-coated electrodes, gold, or gold-coated electrodes, silver or silver-coated electrodes, graphite electrodes, etc.

With respect to the size and positioning of suitable electrodes, it is generally preferred that the electrodes are sized and positioned such that (a) the electric field between the electrodes overlaps at least in part with the analyte compartment, and (b) that the electrodes contact the medium such that at least part of the OH⁻ ions generated by the cathode will migrate towards the anode (preferably at least across the CMM membrane into the analyte compartment). Thus, suitable electrodes may be configured as wires, plates, grids, or even as integral parts of the housing. Furthermore, it should be appreciated that while in some preferred configurations the electrodes are juxtaposed at the same height, other electrode configurations include those in which the height of one electrode is offset relative to the other electrode. Consequently, the electric field across the analyte compartment in contemplated configurations may be perpendicular relative to the housing and/or CMM membrane, or at an angle between about 1 degree and 89 degrees, more typically between 15 degrees and 75 degrees, and most typically between 30 degrees and 65 degrees.

Moreover, it should be recognized that contemplated systems may include multiple electrodes, wherein at least some of the electrodes will provide for electrolysis of the medium (preferably electrolysis of water), while other electrodes may form the electric field in which at least part of the analyte compartment is disposed.

There are numerous cation and anion exchange resins for the anode, cathode, and analyte compartments known in the art, and it is contemplated that all known resins are suitable for use in conjunction with the teachings presented herein. An exemplary selection of suitable resins is described, for example, in “Ion Chromatography” by James S. Fritz, Douglas T. Gjerde, in “Ion Exchange: Theory and Practice (Royal Society of Chemistry Paperbacks)” by C. E. Harland (Springer Verlag; ISBN: 0851864848), or in “Ion-Exchange Sorption and Preparative Chromatography of Biologically Active Molecules (Macromolecular Compounds)” by G. V. Samsonov (Consultants Bureau; ISBN: 0306109883).

Particularly contemplated exchange resins for the anode and cathode compartment include those with relatively high stability towards reduction and oxidation of the functional groups under conditions required to separate a desired analyte from a sample fluid, and especially preferred resins for the anode and cathode compartment have a relatively high capacity for H⁺/OH⁻ exchange. Furthermore, it is generally preferred that suitable resins are in solid phase and that at least some of the resin is in contact with the respective electrode.

With respect to a particular cation/anion exchange resin for the analyte compartment, it is generally contemplated that all resins are especially suitable that will bind a desired analyte. There are numerous types of anion and cation exchange resins with various binding strengths known in the art, and it is contemplated a person of ordinary skill in the art will readily identify a particular resin suitable for the analyte without undue experimentation. Furthermore, and especially where the analyte is an amphoteric molecule it should be appreciated that the pH of the fluid containing the analyte may be adjusted according to a particular ion exchange resin.

In still further contemplated aspects, and especially where contemplated devices are configured as CMM buffered electrodialysis devices, the analyte compartment may include both anion and cation exchange resins. While not limiting to the inventive subject matter, it is generally preferred that where the analyte compartment comprises cation and anion exchange resins, the resins are arranged in an ordered sequence. For example, suitable sequences include multiple layers of resins in which a cation exchange resin alternates with an anion exchange resin, and wherein at least some of the resins extend across the entire width of the analyte compartment.

Suitable charge-mosaic membranes may be prepared using numerous methods well known in the art. For example, cation exchange resins may be combined with anion exchange resins using a polystyrene binder (see e.g., U.S. Pat. No. 2,987,472) or a silicone resin (see e.g., J. N. Weinstein et al., Desalination, 12, 1(1973)). Alternatively, suitable membranes may also be fabricated by casting or blending polymer phases (see e.g., J. Shorr et al., Desalination, 14, 11(1974) or Japanese Laid-Open Specification No. 14389/1979). Still further suitable methods include ionotropic-gel membrane methods (see e.g., H. J. Purz, J. Polym. Sci., Part C, 38, 405(1972)), latex-polymer electrolyte methods (see e.g., Japanese Laid-Open Specification No. 18482/1978), or block copolymerization methods (see e.g., Y. Isono et al., Macromolecules, 16, 1(1983)). In yet further contemplated methods, a cationic, anionic, or neutral polymer may be derivatized to include positive and negative charges suitable for ion exchange.

Where cationic and anionic polymers are employed to form a charge mosaic membrane, cationic polymers preferably include primary, secondary or tertiary amino groups, quaternary ammonium groups, or salts thereof, while anionic polymers preferably include sulfonic groups, carboxylic groups or salts thereof Suitable cationic polymers include polyvinylpyridine and quaternized products thereof; poly(2-hydroxy-3-methacryloyloxypropyltrimethylammonium chloride); poly(dimethylaminoethyl methacrylate), poly(diethylaminoethyl methacrylate), and copolymers with other monomers and/or polymers. Suitable anionic polymers include poly-(2-acryloylamino-2-methyl-1-propanesulfonic acid), poly(2-acryloylamino-2-propanesulfonic acid), polymethacryloyloxypropylsulfonic acid, polysulfopropyl methacrylate, poly(2-sulfoethyl methacrylate), polyinylsulfonic acid, polyacrylic acid, polystyrene-maleic acid copolymers, and copolymers with other monomers and/or polymers.

Furthermore, at least one of the cationic and anionic polymers may be crosslinked using crosslinkers well known in the art. Among numerous alternative crosslinkers, contemplated crosslinkers include divinylbenzene, methylenebisacrylamide, ethylene glycol dimethacrylate and 1,3-butylene glycol dimethacrylate as well as tri- or tetra-functional acrylates and methacrylates. Still further contemplated charge mosaic membranes include those described in U.S. Pat. No. 4,976,860 to Takahashi and U.S. Pat. No. 5,304,307 to Linder et al.

In still further contemplated aspects of the inventive subject matter, it should be recognized that suitable membranes may also be configured to be permeable for charged and non-charged molecules depending on the molecular weight. For example, in such membranes, permeability may be achieved by imparting nanoporosity into the membrane using technologies well known to the person of ordinary skill in the art. Thus, suitable CMM membranes may be a barrier for molecules with various molecular weights, and it is generally contemplated that a particular degree of porosity will predominantly determine the molecular weight cut-off characteristics of such membranes. For example, where relatively small pores are formed in the membrane, suitable molecular weight cut-off may be in the range of between about 300 Da to 3,000 Da. Where somewhat larger porosity is generated, the molecular weight cut-off may be in the range of between about 3,000 Da to 50,000 Da, and where relatively large pores arte generated, the molecular weight cut-off may be in the range of between about 50,000 Da to 200,000 Da, and even higher.

Similarly, it should be recognized that appropriate cation exchange membranes that separate the anode compartment from the analyte compartment include all or almost all of the known cation exchange membranes. However, suitable cation exchange membranes especially include solid polymer electrolyte (SPE) membranes with a relatively high permeability for protons and a relatively low permeability for solvent. There are numerous SPE membranes known in the art, and various aspects of exemplary SPE membranes are described, for example, in U.S. Pat. No. 3,528,858 to Hodgdon et al, U.S. Pat. No. 3,282,875 to Connolly et al, U.S. Pat. No. 5,635,041 to Bahar et al, and U.S. Pat. No. 5,422,411 to Wei et al.

In a further aspect of the inventive subject matter, the origin and composition of contemplated samples may vary considerably, and it is generally contemplated that the origin and composition of the sample is not limiting to the inventive subject matter. However, contemplated samples are preferably processed or unprocessed biological fluids and especially include ionic species of polynucleotides, polypeptides, charged lipids, and/or charged carbohydrates. Thus, contemplated samples may be prepared or isolated from cell cultures, virus and bacterial cultures, animals (and particularly human), plants and/or fungi. Alternatively, suitable samples also include samples from isolated or open environments. For example, samples from isolated environments include process fluids from processing plants (pharmaceutical, food, etc.) while fluids from an open environment may include water samples from a river or other body of water, air, etc.

Furthermore, it should be appreciated that the sample may be provided for various purposes. Among other things, a sample may be provided to remove, reduce the concentration, or determine presence of one or more analytes. Thus, suitable samples may include water, run-off from a process, etc. On the other hand, samples may also be provided to isolate or concentrate one or more analytes. Consequently, suitable samples may include biological fluids, chromatographic preparations, etc.

It is generally preferred, however, that preferred samples include water to at least some degree, and where a particular sample has a relatively low water content (e.g., less than 10 vol %), it is contemplated that the sample may be subjected to a sample preparation step to provide a higher water content. Furthermore, it should be recognized that contemplated samples may be processed to exhibit a particular pH. For example, where an analyte is known to have a neutral charge at a first pH, the pH may be adjusted to an alkaline pH with an appropriate base to facilitate binding of the analyte to the anion exchange resin in the analyte compartment.

Consequently, contemplated analytes will particularly include those that will exhibit an electric charge at a particular pH, and suitable analytes include inorganic analytes, organic analytes, and biological analytes. For example, inorganic analytes include elemental ions (e.g., F⁻, Cl⁻, etc.) and organic and/or inorganic complex ions (e.g., nitrate, carbonate, zirconate, etc.). Organic analytes may include aliphatic, aromatic, and other hydrocarbonaceous ionic molecules, while biological analytes may include ionic forms of nucleic acids, peptides, carbohydrates.

Thus, suitable media particularly include aqueous media, however, in alternative aspects, contemplated media may also include one or more water-miscible or water-immiscible organic solvents. Exemplary contemplated water-miscible organic solvents include dimethylsulfoxide, dimethylformamide, various alcohols, various esters, etc., while exemplary contemplated water-immiscible organic solvents include various aliphatic hydrocarbons, ethers, etc.

With respect to the voltage that is applied to the electrodes, it should be recognized that a particular voltage will typically be determined by various parameters, including salinity of the medium, electrolysis of the medium, and strength of the non-covalent bond between the analyte and the ion exchange resin in the analyte compartment. Thus, suitable voltages will typically be in the range of about less than 1 Volt and several 100 Volts. However, it is generally preferred that the voltage is between about 1 Volt and about 100 Volt, and more typically between 1.4 Volt and about 50 Volt.

CMM Gradient Separation

In one particularly preferred aspect, contemplated configurations as exemplarily depicted in FIG. 1 may be employed in a system in which a sample is applied to the analyte compartment, wherein the sample comprises an analyte anion that will bind to the anion exchange resin in the analyte compartment. Application of the sample may be performed in a batch-wise manner as well as in a continuous flow manner in an amount that will not lead to complete saturation of the binding sites in the anion exchange resin. Upon binding of the analyte anion to the anion exchange resin, a voltage is applied to the electrodes such that two effects will additively (or even synergistically) elute the analyte anion from the anion exchange resin.

First, the analyte anion will be subjected to the electric field force between the anode and cathode. Second, electrolysis of the medium (typically water) will generate a competing anion (typically OH⁻) at the cathode, wherein the competing anion will migrate towards the anode (via the anion exchange resin in the cathode compartment and the CMM membrane). Consequently, an increasing electric field in contemplated configurations will not only provide an increased electrophoretic force, but also (in addition to the generated competing OH⁻ anions) an increased electroactivity of the competing anion. While not wishing to be bound by a particular hypothesis or theory, the inventors contemplate that an increase in the electric field will increase the kinetic force of the competing anion by increasing the mobility and force of interaction of the competing anion with the bond between the anion of the analyte and the anion exchange membrane, thereby increasing the elution force of the competing anion. Viewed from another perspective, an increasing electric field may act in a similar manner to an increase in an exogenously added competing ion (the gradient in a traditional ion exchange chromatography). Thus, the inventors contemplate that the electric field will act as the gradient in this configuration.

Consequently, it should be especially appreciated that elution of the anion of the analyte may take place without addition of an external anion (i.e., anion not already present in the sample that is applied to the analyte compartment) that will compete with the analyte anion. Thus, contemplated configurations may not only be employed to separate or concentrate a desired compound from a complex mixture, but also to desalinate or otherwise clean up a sample. For example, a sample may be applied to contemplated separation systems and once the analyte has bound, the buffer or (other solvent) may be exchanged for another buffer or solvent. Elution of the analyte anion into the new buffer of solvent will then be performed by increase of the electrical field between the anode and cathode (effectively only water via recombination of H⁺ and OH⁻ will be added to the analyte compartment). However, in alternative aspects of the inventive subject matter, it should also be recognized that elution of the analyte anion may further be assisted by addition of external anions to the analyte compartment.

Moreover, it should be recognized that various anions in a sample may exhibit various elution characteristics (i.e., a first anion is eluted at a first potential between anode and cathode, while a second anion is eluted at a second potential between anode and cathode). Thus, contemplated configurations may also be employed to separate multiple anionic components from a complex mixture by virtue of their inherent elution characteristics at a particular voltage between anode and cathode. In fact, it is even contemplated that such systems may not only resolve chemically distinct molecules in a separation, but may also resolve stereoisomers of the same compound by virtue of asymmetric charge distribution in the stereoisomers.

In yet further aspects of the inventive subject matter, it is contemplated that not only anions may be separated, concentrated, or isolated from a complex mixture, but that contemplated configurations may also be employed for cation separation, concentration, and/or isolation. In such configurations, the polarity and arrangement of the ion exchange resins, ion exchange membrane, and the CMM membrane are inverted.

CMM Buffered Electrodialysis

In another especially preferred aspect, contemplated configurations as exemplarily depicted in FIG. 2 may be employed in a system in which a complex sample is applied to the analyte compartment, wherein the sample comprises a plurality of analyte anions and a plurality of analyte cations that will bind to the respective ion exchange resins in the analyte compartment. Application of the sample may be performed in a batch-wise manner as well as in a continuous flow manner in an amount that will not lead to complete saturation of the binding sites in the anion and cation exchange resins. Upon binding of the analyte ions to the ion exchange resins, a voltage is applied to the electrodes such that two effects will additively (or even synergistically) elute the analyte anion from the anion exchange resin.

First, the analyte anion will be subjected to the electric field force between the anode and cathode. Second, electrolysis of the medium (typically water) will generate a competing anion (typically OH⁻) at the cathode, wherein the competing anion will migrate towards the anode (via the anion exchange resin in the cathode compartment and the CMM membrane). Consequently, an increasing electric field in contemplated configurations will not only provide an increased electrophoretic force, but also (in addition to the generated competing OH⁻ anions) an increased electroactivity of the competing anion. Similarly, the analyte cation will first be subjected to the electric field force between the anode and cathode. Second, electrolysis of the medium (typically water) will generate a competing cation (typically H⁺) at the anode, wherein the competing cation will migrate towards the cathode (via the cation exchange resin in the anode compartment and the CMM membrane). Consequently, an increasing electric field in contemplated configurations will not only provide an increased electrophoretic force, but also (in addition to the generated competing H⁺/OH⁻ anions) an increased electroactivity of the competing cation and anion.

Thus, it should be especially appreciated that (a) the analyte ions in a sample will be eluted in an ion pair (hence the term ‘buffered electrodialysis’), and that (b) the bound cation and anion will be eluted from their respective resins by an eluent generated by electrolysis of the medium. (Again, effectively only water via recombination of H⁺ and OH⁻ will be added to the analyte compartment). However, in alternative aspects of the inventive subject matter, it should also be recognized that elution of the analyte anion may further be assisted by addition of external anions to the analyte compartment. With respect to the separation, concentration, and isolation aspects of contemplated CMM buffered electrodialysis, the same considerations as described above apply.

### EXAMPLES

The following examples are provided to further illustrate the inventive subject matter, and especially to provide further guidance to a practitioner with respect to CMM gradient separation and CMM buffered electrodialysis.

### CMM Buffered Electrodialysis

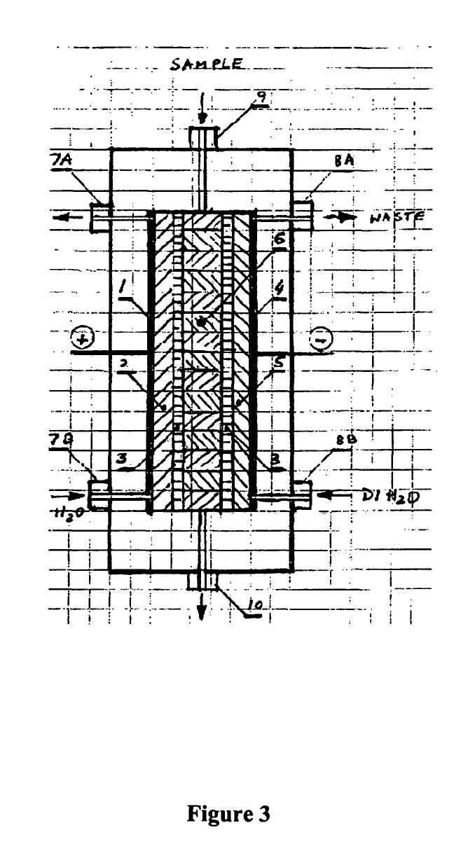

Device description: Basic elements of CMM buffered electrodialysis are shown in FIG. 3. All ion-exchange materials are made similar to CMM Gradient Separation device. 1-Anode, 2-Anion-exchange screen, 3-Charge mosaic membrane, 4-Cathode, 5-Cation-exchange screen, 6-Bi-charge screen. The screen is prepared by thermally stitching 4 mm wide strips of cation- and anion-exchange screens together. Dimensions 5 cm wide and 20 cm high. 7-Anode compartment water flow ports, 8-Cathode compartment water flow ports, 9-Sample port, 10-Analyte port.

Continuous Operation Mode: This mode can be used for water desalination and/or demineralization or for separation inorganic and organic (high molecular weight) component of the solution. Molecular weight cut-off of the organic component of the solution is limited by porosity of charge-mosaic membranes.

Start water flow through anode and cathode compartments using ports 7 A&B and cathode compartment using ports 8 A&B at flow rate of 1 mL/min.

Electric potential between anode and cathode is high enough to flow electric current at density of 25-to 50-mA/cm2

After period of stabilization, sample is starting to flow at rate of 50 mL/min. If sample contains only inorganic component, fraction of the desalted water can be rerouted and flow through anode and cathode compartments. Otherwise, the high molecular weight component would be eluted and flown out through port 10.

Periodic (batch) Operation Mode: This mode can be used to separate inorganic and organic component of separated solution.

Start water flow through anode and cathode compartments using ports 7 A&B and cathode compartment using ports 8 A&B at flow rate of 0.5 mL/min.

Electric potential between anode and cathode is high enough to flow electric current at density 1-to 5-mA/cm²

Sample of few hundreds milliliters of sample solution is flown through port 9 at rate of 2 mL/min. Total concentration of ionic, organic components (for example proteins) has to be lower then total ion-exchange capacity of analytical anion-exchange screen. Inorganic components are removed via charge-mosaic membrane. The organic components of the solution are immobilized on anion- or cation exchange parts of the bi-charge analytical screen.

After sample run is finished, clean water is starting to flow at rate of 1 to 2 mL/min and electric potential is gradually increased. Consecutively all deposited components are eluted and can be collected.

Notice: Flow of all organic, non-ionic components of the sample through the device is unaffected.

### CMM Gradient Separation (CMM Gradient Electrophoresis)

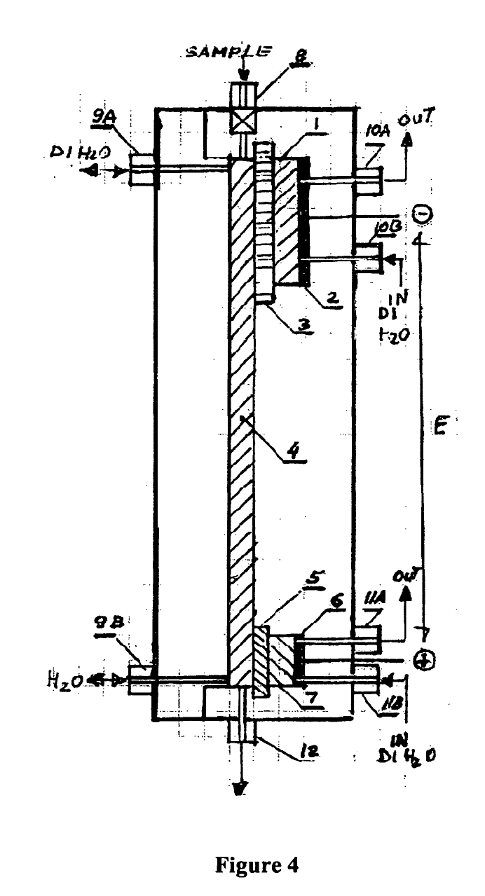

Device description: The basic elements of CMM Gradient Separation are shown on FIG. 4. 1-Anion-exchange screen in cathode compartment; Grafted poly(chloromethylstyrene) on polyethylene screen subsequently quaternized with trimethylamine. Surface charge density about 0.05-0.15 meqiv/cm². 2-Cathode made of corrosion-resistant material; 3-Charge-mosaic membrane, separating cathode from analytical compartment, made from modified polyethylene (R. Gajek et al., J. Polym. Sci., Polym. Phys. Ed., Vol. 19, 1663-1673 (1981)). 4-Anion-exchange analytical screen—same as 1. Dimensions: 1 cm×5 cm×0.2 cm. Total resistivity of 20-200 ohm. 5-Cation-exchange membrane separating anode from analytical compartment—any commercially available strong cation-exchange membrane; 6-Anode made as cathode 2. 7-Cation-exchange screen in anode compartment—made by grafting of polystyrene on polyethylene screen and subsequent chlorosulfonation and hydrolysis in NaOH solution. Surface charge density about 0.05-0.15 meqiv/cm²; 8-Sample injection port with septum for syringe injection of samples; 9-A&B—analytical water ports; 10-A&B—cathode water ports; 11-A&B—anode water ports; 12-Sample outlet port.

Analytical Mode:

Start water flow through anode compartment using ports 11A & B & and cathode compartment using ports 10A & B at flow rate of 2 mL/min.

Apply electric potential between anode and cathode of 1-2 V.

After period of stabilization, sample of 1.0-50 microL can be injected through port 8.

Depending on the sample composition, electric gradient value and duration has to be established for every analysis. At 100 ohm of total system resistivity at 2 V applied potential, current of 20 mA will produce water flow of approximately 0.2 mL/min. At low electric potential (less then 1V) higher water flow can be achieved by flowing additional amount of water through ports 9A and/or 9B.

Separated components can be analyzed using conductivity and/or UV-VIS detectors or can be directly injected to mass spectrum devices. The system can be used for analytical preparative purposes by collecting separated component using variety of laboratory equipment.

Cleaning Procedure:

Start to flow water through analytical compartment using port 9B as an inlet and 9A as an outlet at rate of 2-4 mL/min.

Change polarity of electrodes and apply 2-5 V of electric potential. Notice: in such configuration water electrolysis will occur between cation-exchange membrane (5) and analytical screen (4). Resulting H+ and OH− ions will flow in opposite directions comparing to analytical mode.

Thus, specific embodiments and applications of improved separation systems with charge mosaic membranes have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A separation system comprising:
a cathode, an anode, and a first ion bound by a first ion exchange resin, wherein the first ion exchange resin is at least partially disposed between the cathode and the anode and separated from at least one of the anode and cathode by a charge mosaic membrane;
wherein the cathode, the anode, and the ion exchange resin are at least partially disposed in a medium; and
wherein the first ion is eluted from the resin using (a) a voltage that is applied between the anode and cathode and (b) a second ion that is generated by electrolysis of the medium.

2. The separation system of claim 1 wherein the first ion is an anion, the first ion exchange resin is an anion exchange resin that is separated from the cathode by the charge mosaic membrane, and wherein the second ion is a hydroxyl ion.

3. The separation system of claim 2 wherein the medium comprises water.

4. The separation system of claim 3 wherein the second ion reacts with an H⁺ ion generated at the anode to form water.

5. The separation system of claim 1 further comprising a second ion exchange resin at least partially disposed between the anode and the first ion exchange resin.

6. The separation system of claim 5 further comprising a cation exchange membrane at least partially disposed between the first and second ion exchange resin.

7. The separation system of claim 6 wherein the charge mosaic membrane is at least partially disposed between the cathode and the first ion exchange resin.

8. A separation system comprising an ion exchange resin that binds an ion from a fluid, wherein the ion is eluted from the resin using (a) an electric field generated between an cathode and a anode and (b) a second ion that is generated by electrolysis of the fluid by the cathode and the anode, and wherein a charge mosaic membrane separates the ion exchange resin from the cathode, thereby allowing migration of OH⁻ ions from the cathode to the ion exchange resin and migration of cations from the ion exchange resin to the cathode.

9. (canceled)

10. The separation system of claim 8 wherein elution of the ion from the fluid further comprises addition of a third ion.

11. The separation system of claim 8 wherein the ion exchange resin comprises an anion exchange resin, and wherein the ion is an anion.

12. The separation system of claim 8 wherein the fluid comprises a biological fluid and wherein the ion comprises at least one of a polynucleotide, a polypeptide, a charged lipid, and a charged carbohydrate.

13. The separation system of claim 8 further comprising a third ion that binds to the ion exchange resin, wherein the third ion elutes at an electric field and concentration of the second ion that is different from the elution of the ion from the fluid.

14. A separation system comprising a charge mosaic membrane that is coupled to an ion exchange resin wherein the resin binds an ion from a fluid and wherein the ion is eluted at least in part from the resin using an eluent that is generated by electrolysis of the fluid.

15. The separation system of claim 14 wherein the resin comprises an anion ion exchange resin, and wherein the eluent is an OH⁻ ion.

16. The separation system of claim 14 wherein electrolysis is performed by a current applied to an anode and a cathode, wherein the anode and the cathode are at least partially disposed in the fluid, wherein the resin is at least partially disposed between the anode and the cathode.

17. The separation system of claim 16 wherein elution of the ion is assisted by an electrical field generated between the anode and the cathode.

18. The separation system of claim 14 wherein the fluid comprises a biological fluid and wherein the ion comprises at least one of a polynucleotide, a polypeptide, a charged lipid, and a charged carbohydrate.

19. The separation system of claim 14 wherein elution is further assisted by addition of a second ion to the ion exchange resin.

20. The separation system of claim 19 wherein the second ion is an anion.
